(19) United States
(12) Patent Application Publication
(10) Pub. No.: US 2004/0004608 A1
(43) Pub. Date: Jan. 8, 2004

(54) Display device for reducing power consumption and protecting user's eyes

(75) Inventor: Chiang Hung Lin, Taipei (TW)

Correspondence Address: BROWDY AND NEIMARK, P.L.L.C., 624 NINTH STREET, NW, SUITE 300, WASHINGTON, DC, 20001-5303, US

(73) Assignee: Kinpo Electronics, Inc., Taipei (TW)

(21) Appl. No.: 10/187,949

(22) Filed: Jul. 3, 2002

(51) Int. Cl. G09G 5/00

(52) U.S. Cl. 345/207

(57) ABSTRACT

A display device includes a display panel (LCD) applicable to a portable communication device such as a PDA or a web pad. The display device employs at least one photosensitive resistor for the purpose of sensing the variation of the environmental brightness, thereby adjusting the image brightness of the display panel.

### BACKGROUND OF THE INVENTION

1. Field of the Invention

The invention relates to a display device, and more particularly, to a display device employing photosensitive resistors to adjust the display brightness for images on the display panel according to the variation of environmental brightness.

2. Description of the Related Art

A liquid crystal display (LCD) panel provides a planar display that is broadly used in portable electronic equipment such as portable computers, personal digital assistants (PDA), and recently developed web pads. The principal advantage of the LCD panel lies in a substantial reduction of its size and weight and, furthermore, since the LCD panel has no electron accelerator therewithin, the screen thickness are therefore considerably reduced in comparison with traditional CRT display devices.

Although the numerous advantages described above, LCD panels also have some drawbacks, for example, an inferior display contrast especially as it is operated under relatively high environmental brightness and a narrower angle of view. Regarding some aspects, a LCD device still cannot provide a quality equal to that of the CRT device. Eventually, the display quality is greatly dependent upon the brightness of environment. Although some LCD devices are provided with automatic adjustment of brightness and contrast, these types of adjustment known in the prior art are however in accordance with the displayed frame and further requires a compulsory activation from the user. Therefore, in order to obtain an optimal image display, the user usually has to adjust the display parameters of the LCD device himself. When the brightness of the environment increases, the display contrast or brightness has to be adjusted higher to obtain a better image display. When the environment brightness lowers, the display contrast or brightness has to be lowered for the purpose of better image display and the reduction of the power consumption. For users, manually adjustment no matter via the hardware or software setting is usually cumbersome.

### SUMMARY OF THE INVENTION

It is therefore a principal object of the invention to provide a display device that can automatically adjust the display brightness thereof according to the variation of the environment brightness with the setting of at least one photosensitive resistor.

It is another object of the invention to provide a display device that can provide an optimal image display in accordance with the variation of the environmental brightness, thereby saving a specific amount of power assumption and protecting the user's eyes.

To accomplish the above and other objectives, a display screen device of the invention includes a display panel, at least one photosensitive resistor, and a control circuit having A/D converters and a CPU. The photosensitive resistor is mounted within the display panel. The A/D converter is connected to the photosensitive resistor, the CPU is connected to the display panel. As the environmental brightness increases, the resistance of the photosensitive resistor decreases, and the input voltage of the analog/digital converter increases. Thereafter, the CPU compares the output of the A/D converter with a preset value initially stored to turn the image shown on the display panel to be brighter. If the environmental brightness decreases, the resistance of the photosensitive resistor increases, and the input voltage of the AID converter decreases accordingly. Subsequently, the CPU compares the output of the AID converter with the initially stored preset value to turn image shown on the display panel to be darker. Thereby, this display device may reduce the power consumption thereof significantly and protect the user's eyes.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of a first embodiment of the invention according to the present invention;

FIG. 2 is a circuit diagram of a display device according to a first embodiment of the invention;

FIG. 3 is a perspective view of a second embodiment of the invention according to the present invention; and

FIG. 4 is a circuit diagram of a display device according the second embodiment of the invention.

### DETAILED DESCRIPTION OF THE EMBODIMENTS

Wherever possible in the following description, like reference numerals will refer to like elements and parts unless otherwise illustrated.

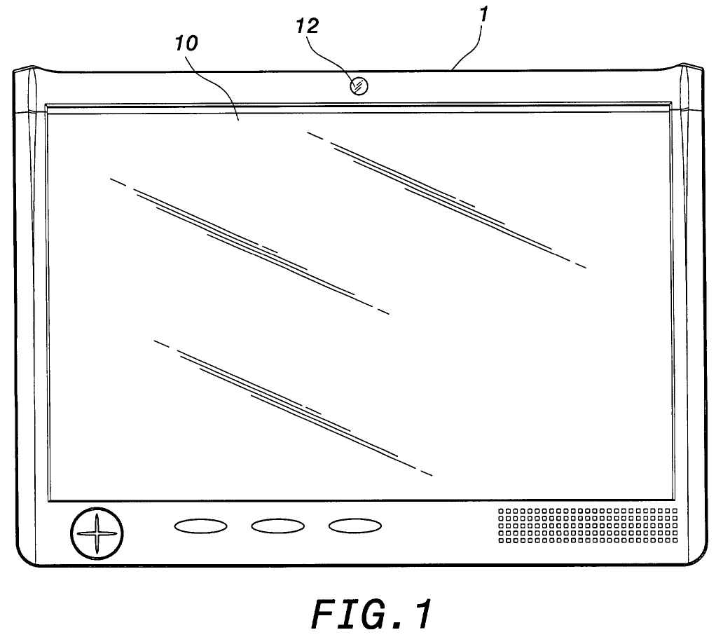

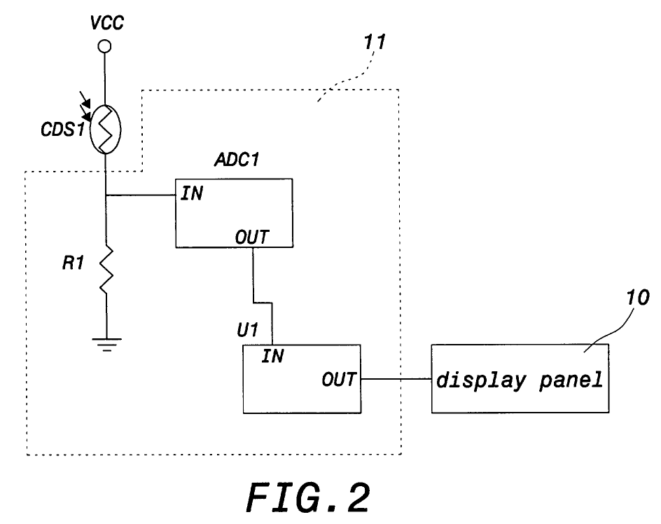

FIG. 1 is a perspective view of a first embodiment 1 according to the present invention. As illustrated, the display device of the invention includes a display panel 10 and is mounted in some portable communication equipment, for example, a PDA or a web pad. In this embodiment, the display device 1 is exemplary illustrated as being used in a web pad. A control circuit 11 is disposed inside the display device 1 (with more details in FIG. 2). The control circuit 11 is electrically connected to the display panel 10 to control the image brightness of the display panel 10. Proximate to a central region of a front face of the display panel 10 is arranged a groove (not shown) to enable the placement of a photosensitive resistor 12. Alternatively, the groove can be properly located on the surface facing the user of the display device 1. The photosensitive resistor 12 is electrically connected to the control circuit 11 and has a resistance that varies according to the environmental brightness variation. Therefore, the brightness of the environmental light with respect to the display device 1 is sensed by the photosensitive resistor 12 and, the resistance thereof changes accordingly. Furthermore, a transparent body (not shown) may additionally cover the photosensitive resistor 12 for the sake of protection.

Referring to FIG. 2, FIG. 2 is a circuit diagram schematically illustrating an internal circuitry of the first embodiment of the invention. As illustrated, the internal circuitry of the invention principally includes the control circuit 11 having a photosensitive resistor 12 (CDS1), a resistor R1, an analog/digital (A/D) converter ADC1, and a CPU U1. One terminal of the photosensitive resistor CDS1 is connected to a constant voltage source Vcc. Other terminals of the photosensitive resistor CDS1 are connected to a ground through the resistor R1 and to an input terminal of the A/D converter ADC1 respectively. An output terminal of the ADC1 is connected to one terminal of the CPU U1. The other output terminal of the CPU U1 is connected to the display panel 10.

With such a configuration, variation of the environmental brightness with respect to the display panel 10 can be sensed. When the brightness of the environmental light increases, the resistance of the photosensitive resistor CDS1 decreases, and accordingly the input voltage of the ADC1 increases. The CPU U1 compares the output of the ADC 1 with a preset value to determine how much adjustment should be imposed on the image brightness of the display panel 10. The CPU U1 then gradually increases the brightness of the light source inside the display panel 10. When the brightness of the environmental light decreases, the resistance of the photosensitive resistor CDS1 increases, and the input voltage of the ADC1 accordingly decreases. The CPU U1 compares the ADC 1 output with the preset value to determine the required decrease of the image brightness of the display panel 10. The CPU U1 then gradually decreases the brightness of the light source inside the display panel 10. Thereby, the power consumption is reduced and the user's eyes are protected.

The brightness of the light emitted from the display panel 10 is therefore adjusted according to the brightness of the environmental light to favorably achieve an optimal power consumption and a protection of the user's eyes.

In the first embodiment of the invention, a single photosensitive resistor 12 is used to detect the change in the environmental brightness. However, more than one photosensitive resistors 12 can be also used to detect the brightness changes at different locations to then obtain an average value of the brightness changes.

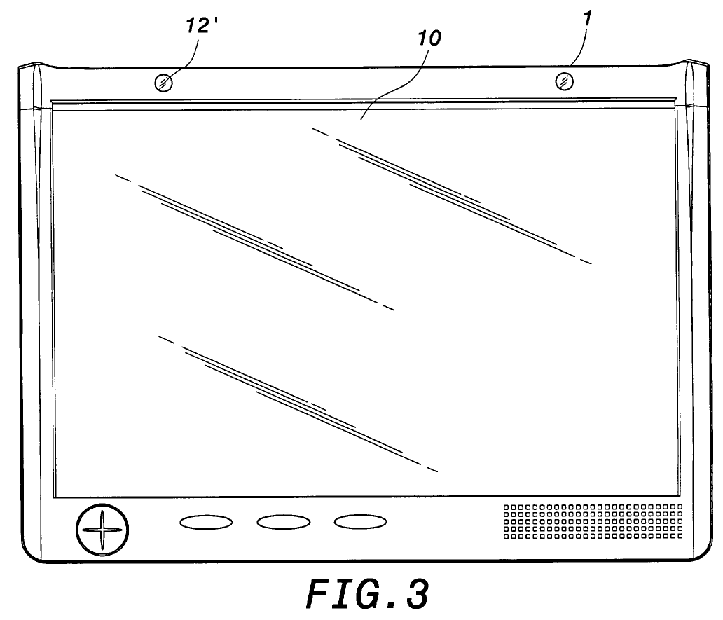

FIG. 3 is a perspective view of a second embodiment according to the present invention. As illustrated, the display device of this embodiment includes a display panel 10. A control circuit 11′ is disposed inside the display device 1 and electrically connected to the display 10. Proximate to the end of the front face of display panel 10 is arranged a groove (not shown) to enable the placement of photosensitive resistors 12′, which are electrically connected to the control circuit 11′. The photosensitive resistors 12′ change their corresponding resistance values according to the variation of the environmental light. Therefore, the environmental brightness is sensed by the changes in respective resistance values. Furthermore, a transparent body (not shown) may additionally cover the photosensitive resistors 12, respectively, for the protection.

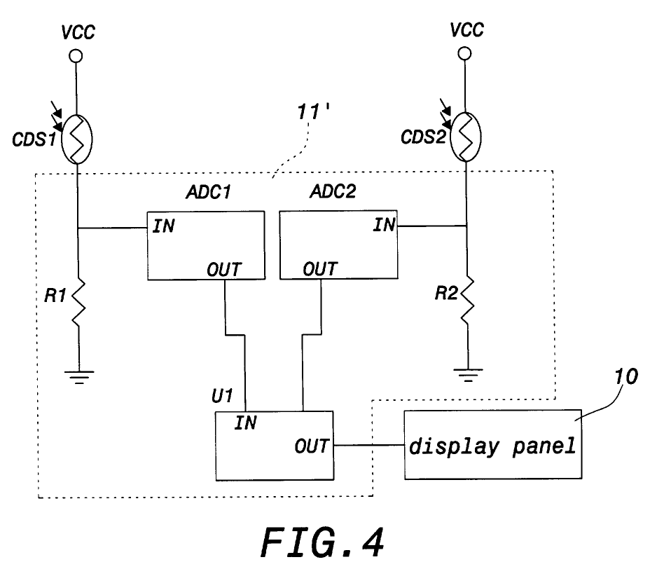

Referring to FIG. 4, a circuit diagram of the second embodiment is schematically illustrated to show an internal circuitry thereof. As illustrated, the internal circuitry of the invention principally includes the control circuit 11′ consists of photosensitive resistors 12 (CDS1, CDS2), resistors R1, R2, analog/digital (A/D) converters ADC1, ADC2, and a CPU U1. One terminal of the photosensitive resistor CDS1 is connected to a constant voltage source Vcc. The other terminal of the photosensitive resistor CDS1 is connected to a ground via the resistor R1 and to an input terminal of the A/D converter ADC1, respectively. An output terminal of the ADC1 is connected to one terminal of the CPU U1. Meanwhile, one terminal of the photosensitive resistor CDS2 is connected to a constant voltage source Vcc. Other terminals of the photosensitve resistor CDS2 are respectively connected to the ground via the resistor R2 and to an input terminal of the ADC2. An output terminal of the ADC2 is also connected to the CPU U1. The other terminal of the CPU U1 is connected to the display panel 10.

With such a configuration, the environmental variation can be sensed. When the brightness of the environmental light increases, the respective resistance values of the photosensitive resistors CDS1, CDS2 decrease, and the input voltages of the ADC1, ADC2 accordingly increase. The CPU U1 compares the respective outputs of the ADC1 and ADC2 to determine how much adjustment of the image brightness should be imposed to the display panel 10. The CPU U1 then gradually increases the brightness of the light source inside the display panel 10. When the brightness of the environmental light decreases, the respective resistance values of the photosensitive resistors CDS1 and CDS2 increase, and the input voltages of the ADC1, ADC2 accordingly decrease. The CPU U1 compares the respective outputs of the ADC1 and ADC2 to determine the required decrease for the image brightness of the display panel 10. The CPU U1 then gradually decreases the brightness of the light source inside the display panel 10. Thereby, the power consumption is reduced and the user's eyes are protected.

With the use of photosensitive resistors CDS1 and CDS2, the brightness of the light emitted from the display panel 10 can be automatically adjusted according to the environmental brightness to favorably obtain goals of optimizing the power consumption and protecting user's eyes.

Furthermore, if the user wants a manual setting of the display device, the CPU U1 then will not consider the outputs from the ADC1 and/or ADC2.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A display device, comprising:
a display panel;
a photosensitive resistor being mounted proximate to the display panel; and
a control circuit placed within the display panel having an analog/digital (A/D) converter connected to the photosensitive resistor and a CPU connected to the display panel;
wherein if an environmental brightness increases, resistance of the photosensitive resistor decreases so as to increase an input voltage of the A/D converter, and inform the CPU of comparing outputs of the AID converter with preset values stored within the CPU, thereby turning images shown on the display panel to be brighter;
and if the environmental brightness turns darker, the resistance of the photosensitive resistor increases to decrease the input voltage of the A/D converter, and inform the CPU of comparing the outputs of the A/D converter with the preset values to turn the images shown on the display panel to be darker.

2. The device of claim 1, wherein the display panel is installed in a portable device such as a PDA or a web pad.

3. The device of claim 1, wherein the display panel is a liquid crystal display (LCD) panel.

4. A display device, comprising:
a display panel;
a plurality of photosensitive resistors being mounted proximate to the display panel; and
a control circuit within the display panel having a plurality of analog/digital (A/D) converters respectively connected to the photosensitive resistors, and a CPU connected to the display panel;
wherein if an environmental brightness increases, the resistances of the photosensitive resistors decrease to increase input voltages of the A/D converters and inform the CPU of comparing outputs of the A/D converters so as to turn images shown on the display panel to be brighter; and if the environmental brightness decreases, the respective resistances of the photosensitive resistors increase to lower the input voltages of the A/D converters, and inform the CPU of comparing outputs of the A/D converters to turn images shown on the display panel to be darker.

5. The device of claim 4, wherein the display panel is installed in a portable device such as a PDA and a web pad.

6. The device of claim 4, wherein the display panel is a liquid crystal display (LCD) panel.
